(19) United States
(12) Patent Application Publication
(10) Pub. No.: US 2007/0114387 A1
(43) Pub. Date: May 24, 2007

(54) Matrix assisted laser desorption ionization (MALDI) support structures and methods of making MALDI support structures

(76) Inventors: Ying-Lan Chang, Cupertino, CA (US); Sungsoo Yi, Sunnyvale, CA (US); Dan-Hui Dorothy Yang, Sunnyvale, CA (US); Jian Bai, Sunnyvale, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/546,610

(22) Filed: Oct. 12, 2006

Related U.S. Application Data
(60) Provisional application No. 60/731,711, filed on Oct. 31, 2005.

(51) Int. Cl. H01J 49/00

(52) U.S. Cl. 250/288

(57) ABSTRACT

Matrix assisted laser desorption ionization (MALDI) sample substrates, methods of fabricating MALDI sample substrates, methods of ionizing a sample, and mass spectrometry systems including MALDI sample substrates, are disclosed.

### CROSS-REFERENCE TO RELATED APPLICATION

This application claims priority to U.S. provisional application entitled, “Matrix assisted laser desorption Ionization (MALDI) support structures and methods of making MALDI support structures,” having Ser. No. 60/731,711, filed on Oct. 31, 2005, which is entirely incorporated herein by reference.

### BACKGROUND

A variety of instruments can be used for analyzing analytes such as biomolecules. More recently, mass spectrometry has gained prominence because of its ability to handle a wide variety of analytes with high sensitivity and rapid throughput. A variety of ion sources have been developed for use in mass spectrometry. Many of these ion sources include some type of mechanism that produces ions in accordance with an ionization process. One particular type of ionization process that is used is Matrix Assisted Laser Desorption Ionization (“MALDI”). MALDI is a technique used to produce ions for mass spectrometry. One benefit of MALDI is its ability to produce ions from a wide variety of analytes, including biomolecules such as proteins, peptides, oligosaccharides, oligonucleotides, and the like. Another benefit of MALDI is its ability to produce ions with reduced fragmentation, thus facilitating identification of analytes from which the ions are produced.

Typically, MALDI produces ions from a co-precipitate of an analyte and a matrix. The matrix can include organic molecules that exhibit a strong absorption of light at a particular wavelength or a particular range of wavelengths, such as in the ultraviolet range. Examples of the matrix include 2,5-dihydroxybenzoic acid, 3,5-dimethoxy-4-hydroxycinnamic acid, α-cyano-4-hydroxycinnamic acid, and the like. For a conventional MALDI mass spectrometry system, an analyte and a matrix are dissolved in a solvent to form a solution, and the solution is then applied to or positioned on a sample support. As the solvent evaporates, the analyte and the matrix form a co-precipitate on the sample support. The co-precipitate is then irradiated with a short laser pulse that induces an accumulation of energy in the co-precipitate through electronic excitation or molecular vibration of the matrix. As the matrix dissipates the energy by desorption, the matrix carries the analyte into a gaseous phase. During this desorption process, ions are produced from the analyte by charge transfer between the matrix and the analyte.

During operation of a conventional MALDI mass spectrometry system, absorption of light by a matrix or by an analyte can affect ionization efficiency for the analyte, which, in turn, can affect sensitivity of mass spectrometric analyses. Accordingly, it is desirable to enhance absorption of light by the matrix or by the analyte, such that mass spectrometric analyses have a desired level of sensitivity.

### SUMMARY

Matrix assisted laser desorption ionization (MALDI) sample substrates, methods of fabricating MALDI sample substrates, methods of ionizing a sample, and mass spectrometry systems including MALDI sample substrates, are disclosed.

Briefly described, one embodiment of the MALDI sample substrate, among others, includes: a MALDI substrate, a metal nanostructure catalyst layer disposed on the substrate, wherein the metal nanostructure catalyst layer includes a discrete set of nanostructures, a silicon nanostructure layer disposed on the metal nanostructure catalyst layer, wherein the silicon nanostructure layer includes a discrete set of nanostructures, and a silicon dioxide (SiO₂) layer formed on the silicon nanostructure layer.

An embodiment of a method of fabricating MALDI sample substrates, among others, includes: providing a sample support as described above, positioning the sample on the sample support, and ionizing the sample.

An embodiment of a method of ionizing a sample, among others, includes: providing a sample support comprising a sample support as described above, positioning the sample on the sample support, and ionizing the sample.

An embodiment of a method of ionizing a sample, among others, includes: an ion source configured to produce ions and comprising: a light source; and a sample support, as described above, adjacent to the light source and configured to support a sample, and a detector downstream with respect to the ion source and configured to detect the ions.

Other systems, methods, features, and advantages of the present disclosure will be or become apparent to one with skill in the art upon examination of the following drawings and detailed description. It is intended that all such additional systems, methods, features, and advantages be included within this description, be within the scope of the disclosure, and be protected by the accompanying claims.

### BRIEF DESCRIPTION OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a cross sectional view of a matrix assisted laser desorption ionization (MALDI) sample substrate.

FIGS. 2A through 2D illustrate cross sectional views that illustrate an embodiment of a method for forming the MALDI sample substrate shown in FIG. 1.

FIG. 3 illustrates a mass spectrometry system 20 implemented in accordance with embodiments of the MALDI sample substrate.

FIG. 4 is an AFM picture of a nanostructured Au/Si/SiO₂ surface.

FIG. 5 illustrates a MALDI measurement using a titanium nitride surface, while FIG. 6 illustrates a MALDI measurement on nanostructured Au/Si/SiO₂ surface.

### DETAILED DESCRIPTION

Embodiments of the present disclosure will employ, unless otherwise indicated, techniques of synthetic organic chemistry, biochemistry, molecular biology, semiconductor manufacturing techniques, and the like, that is within the skill of the art. Such techniques are explained fully in the literature.

The following examples are put forth so as to provide those of ordinary skill in the art with a complete disclosure and description of how to perform the methods and use the compositions disclosed and claimed herein. Efforts have been made to ensure accuracy with respect to numbers (e.g., amounts, temperature, etc.) but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

As used herein, the term “set” refers to a collection of one or more elements. Thus, for example, a set of nanostructures can comprise a single nanostructure or multiple nanostructures. Elements of a set can also be referred to as members of the set. Elements of a set can be the same or different. In some instances, elements of a set can share one or more common characteristics.

As used herein, the term “adjacent” refers to being near or adjoining. Adjacent structures can be spaced apart from one another or can be in actual contact with one another. In some instances, adjacent structures can be coupled to one another or can be formed integrally with one another.

As used herein, the term “ionization efficiency” refers to a ratio of the number of ions produced in an ionization process and the number of electrons or photons used in the ionization process.

As used herein, the term “ultraviolet range” refers to a range of wavelengths from about 150 nanometer (nm) to about 400 nm.

As used herein, the term “nanometer range” or “nm range” refers to a range of sizes from about 0.1 nm to about 1,000 nm, such as from about 0.1 nm to about 500 nm, from about 0.1 nm to about 100 nm, from about 0.1 nm to about 50 nm, or from about 0.1 nm to about 110 nm.

As used herein, the term “aspect ratio” refers to a ratio of a largest dimension of a structure and an average of remaining dimensions of the structure, which remaining dimensions are orthogonal with respect to one another and with respect to the largest dimension. In some instances, remaining dimensions of a structure can be substantially the same, and an average of the remaining dimensions can substantially correspond to either of the remaining dimensions. Thus, for example, an aspect ratio of a cylinder refers to a ratio of a length of the cylinder and a cross-sectional diameter of the cylinder. As another example, an aspect ratio of a spheroid refers to a ratio of a major axis of the spheroid and a minor axis of the spheroid.

As used herein, the terms “reflective,” “reflecting,” and “reflection” refer to a bending or a deflection of light. A bending or a deflection of light can be substantially in a single direction, such as in the case of specular reflection, or can be in multiple directions, such as in the case of diffuse reflection or scattering. Reflective materials typically correspond to those materials that produce reflected light when those materials are irradiated with incident light. The reflected light and the incident light can include wavelengths that are the same or different.

As used herein, the terms “inert” and “inertness” refer to a lack of interaction. Inert materials typically correspond to those materials that exhibit little or no tendency to interact with a sample under typical operating conditions, such as typical operating conditions of the sample supports described herein. Typically, inert materials also exhibit little or no tendency to interact with ions produced from a sample in accordance with an ionization process. While a material is sometimes referred to herein as being inert, it is contemplated that the material can exhibit some detectable tendency to interact with a sample under certain conditions. One measure of inertness of a material is its chemical reactivity. Typically, the material is considered to be inert if it exhibits little or no chemical reactivity with respect to a sample.

As used herein, the term “nanostructure” refers to a structure that includes at least one dimension in the nm range. A nanostructure can include any of a wide variety of shapes and can be formed from any of a wide variety of materials. Examples of nanostructures include, but are not limited to, nanoparticles.

As used herein, the term “nanoparticle” refers to a spheroidal nanostructure. Typically, a nanoparticle includes dimensions in the nm range and an aspect ratio that is less than about 2. Thus, for example, a nanoparticle can include a major axis and a minor axis that are both in the nm range. Nanoparticles can be formed using any of a wide variety of techniques, such as aqueous synthetic routes, electron beam evaporation, chemical vapor deposition, and the like.

As used herein, the term “metal nanostructure catalyst layer” refers to a material that includes or is formed from a set of nanostructures. One example of a metal nanostructure catalyst layer is one that includes or is formed from a set of nanoparticles, namely a nanoparticle material. In some instances, a metal nanostructure catalyst layer can include a substantially ordered array or arrangement of nanostructures and, thus, can be referred to as being substantially ordered. For example, a metal nanostructure catalyst layer can include an array of nanostructures that are substantially aligned with respect to one another or with respect to a certain axis, direction, plane, surface, or three-dimensional shape. As another example, a metal nanostructure catalyst layer can include an array of nanostructures that are substantially regularly spaced with respect to one another or with respect to a certain lattice, such as any of a wide variety of two-dimensional lattices and three-dimensional lattices.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range.

All patents, patent applications, and publications mentioned herein are hereby incorporated by reference in their entireties.

Discussion

Matrix assisted laser desorption ionization (MALDI) sample substrates, mass spectrometry systems including the MALDI sample substrates, methods of ionization, and methods of fabricating MALDI sample substrates are provided. In general, the MALDI sample substrates includes a substrate, a metal nanostructure catalyst layer, a silicon nanostructure layer, and a silicon dioxide (SiO₂) layer. The metal nanostructure catalyst layer and the silicon nanostructure layer each include a set of discrete nanostructures. The metal nanostructure catalyst layer is disposed on the substrate, while the silicon nanostructure layer is disposed on the metal nanostructure catalyst layer. The silicon dioxide layer is formed on top of the silicon nanostructure layer. The metal nanostructure catalyst layer can reflect light incident upon the metal nanostructure catalyst layer. Moreover, the metal nanostructure catalyst layer is buried underneath the silicon nanoparticle layer, thus the interaction between the analytes and metal is prohibited. In this way, a sample disposed on the silicon dioxide layer can be desorbed/ionized by the light directed at the sample as well as the light reflected from the metal nanostructure catalyst layer. Use of this type of MALDI sample substrates can result in enhanced desorption/ionization efficiency. Furthermore, the MALDI sample substrates can be formed using standard semiconductor microprocessing techniques, which provides a less expensive method of fabrication.

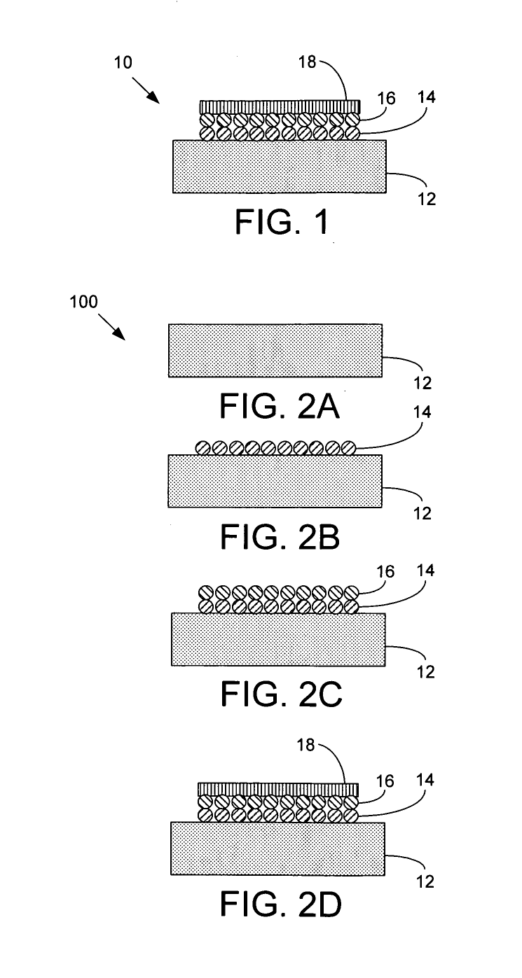

FIG. 1 is a cross sectional view of a MALDI sample substrate 10. The MALDI substrate 10 includes, but is not limited to, a substrate 12, a metal nanostructure catalyst layer 14, a silicon nanostructure layer 16, and a silicon dioxide (SiO₂) layer 18. It should be noted that the metal nanostructure catalyst layer 14 and the silicon nanostructure layer 16 are composed of discrete nanostructures. The metal nanostructure catalyst layer 14 is disposed on the substrate 12, while the silicon nanostructure layer 16 is disposed on the metal nanostructure catalyst layer 14. The silicon dioxide layer 18 is formed on the silicon nanostructure layer 16 via oxidation by oxygen in air, for example.

The substrate 12 can be made of a material such as, but not limited to, siliceous materials (e.g., silicon dioxide, glasses, fused silica, ceramics, and the like), metals, polymers, and others that are able to withstand the rigors of metal catalyst deposition and silicon nanoparticle growth condition for MALDI substrate manufacturing. The dimensions can be of those typically used in MALDI processes.

The metal nanostructure catalyst layer 14 includes a set of nanostructures, where the nanostructures are adjacent one another. The nanostructures can include, but are not limited to, nanoparticles. In particular the nanostructure can be made of materials such as, but not limited to, gold, silver, titanium, nickel, cobalt, oxides of each, and combinations of each. The metal nanostructure catalyst layer 14 can have a thickness of about 2 to 50 nanometers (nm), about 5 to 20 nm, and about 10 to 20 nm. The metal nanostructure catalyst layer 14 can include about 1 to 2 layers of nanostructures, each layer being about 5 to 9 nm. The nanostructures can have a diameter of about 5 to 9 nm.

The metal nanostructure catalyst layer 14 can be formed by techniques such as, but not limited to, electron-beam evaporation and the like. The spacing (e.g., density of the nanostructures) of the nanostructures adjacent one another can be controlled, at least in part, by the fabrication conditions. In this regard, the spacing can be controlled to produce a metal nanostructure catalyst layer appropriate for a particular MALDI application. The metal nanostructure catalyst layer 14 acts as nucleation sites for the subsequent Si nanoparticles deposition, as discussed below.

The silicon nanostructure layer 16 includes a set of silicon nanostructures, where the nanostructures are adjacent one another. The silicon nanostructure layer 16 can have a thickness of about 2 to 50 nm, about 5 to 20 nm, about 10 to 20 nm, and about 10 nm. It should be noted that the thickness of the silicon nanostructure layer 16 could be controlled by modifying fabrication conditions. Therefore, the thickness can be optimized for particular uses of the MALDI sample plate 10. The nanostructures can have a diameter of about 8 to 12 nm.

In general, the deposition of silicon nanostructure layer 16 is performed in a chemical vapor deposition reactor. Typically, the substrate 12 with the metal nanostructure catalyst layer 14 is mounted on a susceptor and is heated to a deposition temperature (about 400-700° C.) and a gaseous precursor mixture is passed over the substrate 12 and nanostructure catalyst layer 14. The gaseous precursor mixture contains a Si precursor such as silane (SiH₄) or disilane (Si₂H₆), for example, and carrier gas, such as H₂ or N₂. As molecules of the gaseous precursor contact the nanoparticles of the metal nanostructure catalyst layer 14, they are catalytically decomposed and a layer of close-packed Si nanoparticles is deposited on the surface of the substrate and metal nanostructure catalyst layer (silicon nanostructure layer 16). Our analysis indicates that the metal nanostructure catalyst layer 14 is substantially buried underneath the silicon nanoparticles layer, where “substantially buried” refers to interaction between the analytes and metal being prohibited or substantially prohibited.

The silicon nanostructure layer 16 can be formed by techniques such as, but not limited to, chemical vapor deposition (CVD) and the like. The spacing (e.g., density of the nanostructures) of the nanostructures adjacent one another can be controlled, at least in part, by the fabrication conditions and the metal nanostructure catalyst layer 14. In this regard, the spacing can be controlled to produce a silicon nanostructure layer appropriate for a particular MALDI application.

The silicon dioxide layer 18 is formed on the silicon nanostructure layer 16. The silicon dioxide layer 18 can have a thickness of about 2 to 10 angstroms (Å), about 2 to 6 Å, and about 2 to 4 Å. The silicon dioxide layer 18 is formed by oxidation of silicon by oxygen in air. In this regard, the silicon dioxide layer appropriate for a particular MALDI application can be controlled while being formed.

FIGS. 2A through 2D illustrate cross sectional views that illustrate an embodiment of a method 100 for forming the MALDI sample substrate 10 shown in FIG. 1. FIG. 2A illustrates a cross sectional view of the substrate 12. FIG. 2B illustrates the formation of the metal nanostructure catalyst layer 14 on the substrate 12. The metal nanostructure catalyst layer 14 can be formed by techniques such as, but not limited to, electron-beam evaporation and the like.

FIG. 2C illustrates the formation of the silicon nanostructure layer 16. The silicon nanostructure layer 16 can be formed by techniques such as, but not limited to, chemical vapor deposition (CVD), and the like. The silicon nanostructure layer 16 is formed in a manner consistent with the description above.

FIG. 2D illustrates the formation of the silicon dioxide (SiO₂) layer 18 on the silicon nanostructure layer 52. The silicon dioxide layer 18 can be formed by the oxidation of silicon by oxygen in air.

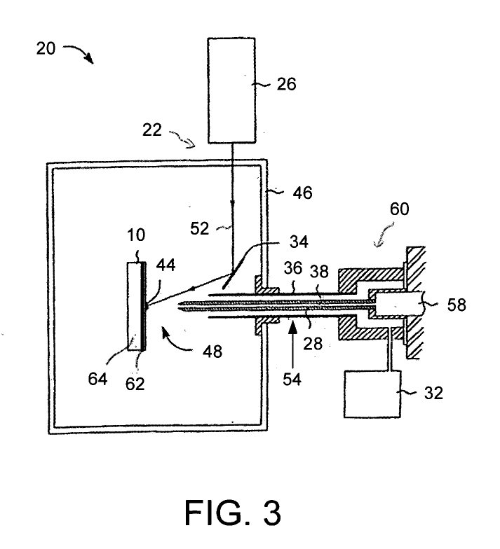

FIG. 3 illustrates a mass spectrometry system 20 implemented in accordance with embodiments of the MALDI sample substrate. The mass spectrometry system 20 includes an ionization source 22, which operates to produce ions. In the illustrated embodiment, the ionization source 22 produces ions using MALDI. However, it is contemplated that the ionization source 22 can be implemented to produce ions using any other ionization process, such as vacuum MALDI or Atmospheric Pressure-Matrix Assisted Laser Desorption Ionization (“AP-MALDI”), Atmospheric Pressure Photo Ionization (“APPI”), and the like. It is also contemplated that the ionization source 22 can be implemented as a multi-mode ion source that produces ions using a combination of ionization processes. As illustrated in FIG. 3, the mass spectrometry system 20 also includes a detector system 60, which is positioned downstream with respect to the ionization source 22 to receive ions. The detector system 60 operates to detect ions as a function of mass to charge ratio.

As illustrated in FIG. 3, the ionization source 22 includes a light source 26, which operates to produce incident light 16. In the illustrated embodiment, the light source 26 is implemented as a laser that produces the incident light 52 in the form of a laser beam. Typically, the laser beam is pulsed and comprises a wavelength or a range of wavelengths in the ultraviolet range. However, it is contemplated that the laser beam need not be pulsed and can include any other wavelength or range of wavelengths.

In the illustrated embodiment, the ionization source 22 also includes a housing 46 that defines an ionization region 48 within which ions are produced. For certain implementations, the ionization region 48 can be maintained at a low pressure, such as under high vacuum conditions. As illustrated in FIG. 3, the ionization source 22 also includes a sample support 10, which is positioned within the ionization region 48 and is optically coupled to the light source 26 via a reflector 34. The MALDI sample substrate 10 operates to support or hold a sample 44 that contains an analyte to be analyzed by the mass spectrometry system 20. For example, the sample 44 can include a co-precipitate of the analyte and a matrix, and the matrix can exhibit a strong absorption of the incident light 52. During operation, the light source 26 produces the incident light 52, which is directed into the ionization region 48 and reaches the MALDI sample substrate 10 via the reflector 34. The incident light 52 interacts with the sample 44 to produce ions from the analyte. The ions are released into the ionization region 48 and eventually reach the detector system 60.

The detector system 60 includes a mass analyzer 54, which operates to separate or select ions by mass-to-charge ratio. In the illustrated embodiment, the mass analyzer 54 is implemented as a time-of-flight analyzer. However, it is contemplated that other types of mass analyzers can be used, such as ion trap devices, quadrapole mass spectrometers, magnetic sector spectrometers, and the like. As illustrated in FIG. 3, the mass analyzer 54 includes a capillary 28, which defines an internal passageway 38. During operation, ions are produced by the ionization source 22, and the ions pass through the capillary 28 via the internal passageway 38.

As illustrated in FIG. 3, the mass analyzer 54 also includes a gas source 32 and a gas conduit 36 that encloses the capillary 28. The gas conduit 36 is fluidly coupled to the gas source 32 and operates to supply an inert gas to the ionization region 48. Referring to FIG. 3, the detector system 60 also includes a detector 58, which is positioned with respect to the mass analyzer 54 to receive ions. During operation, ions pass through the capillary 28 and eventually reach the detector 58, which operates to detect the abundance of the ions and to produce a mass spectrum.

During operation of the mass spectrometry system 20, absorption of light by the sample 44 can affect ionization efficiency for the analyte, which, in turn, can affect sensitivity of mass spectrometric analyses. Accordingly, it is desirable to enhance absorption of light by the sample 44, such that mass spectrometric analyses have a desired level of sensitivity.

The MALDI sample substrate 10 includes the substrate 12, the metal nanostructure catalyst layer 14, the silicon nanostructure layer 16, and the silicon dioxide (SiO₂) layer 18. Advantageously, the metal nanostructure catalyst layer 14 can enhance absorption of light by the sample 44 by reflecting the incident light 52 back towards the sample 44. During operation, a portion of the incident light 52 that is not initially absorbed by the sample 44 passes through the sample 44 and eventually reaches the metal nanostructure catalyst layer 14. In turn, the metal nanostructure catalyst layer 14 can reflect this portion of the incident light 16 back towards the sample 44. In such manner, the metal nanostructure catalyst layer 14 can provide multi-path irradiation of the sample 44 to enhance a capture cross-section of the incident light 52, thus promoting production of ions from the analyte. At the same time, there would be little or no interaction between analytes and metal nanostructure catalyst since the catalyst layer is underneath the silicon nanoparticle layer.

In conjunction with enhancing absorption of light by the sample 44, the MALDI sample substrate 10 can exhibit a number of other characteristics that are desirable for mass spectrometry. For example, another benefit of the MALDI sample substrate 10 is that it can be highly robust. Thus, the MALDI sample substrate 10 can exhibit little or no tendency to degrade under typical operating conditions, thus reducing undesirable chemical background noise in a mass spectrum. Robustness of the MALDI sample substrate 10 can also allow the sample support 10 to be readily cleaned and to be reused for multiple tests. Another benefit of the MALDI sample substrate 10 is that it can be highly inert with respect to typical analytes for mass spectrometry. Accordingly, use of the MALDI sample substrate 10 can reduce undesirable interaction with an analyte for a current test as well as reduce contamination of the MALDI sample substrate 10 with a residual analyte from a previous test.

Another advantage is that the disclosed MALDI substrate provides high reproducibility. As can be perceived from the manufacturing process, e-beam evaporation and CVD can generate very homogeneous catalyst deposition and silicon nanoparticle deposition. At the scale of typical spots for MALDI measurement (mm scale), the reproducibility provided by this substrate is crucial for quantitative measurement.

It should be emphasized that the above-described embodiments of the present disclosure, are merely possible examples of implementations, merely set forth for a clear understanding of the principles of the disclosure. Many variations and modifications may be made to the above-described embodiment(s) of the disclosure without departing substantially from the principles of the disclosure. All such modifications and variations are intended to be included herein within the scope of this disclosure and the present disclosure and protected by the following claims.

### EXAMPLES

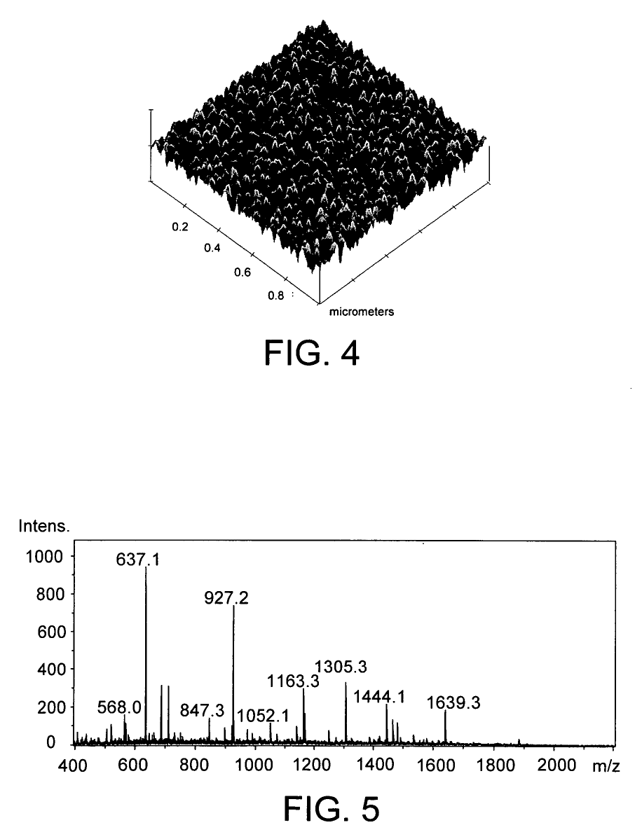

An example of the AFM pictures of a nanostructured Au/Si/SiO₂ surface is shown in FIG. 4. The surface contains closely packed Si nanoparticles (with height about 5-9 nm). The amount of Au detected by XPS is negligible (about 0.3%), indicating that the amount of Si deposited on Au is of the order of about 10 nm. It has been verified that the surface characteristics and layer structures remain unchanged after standard process flow for surface chemical modification.

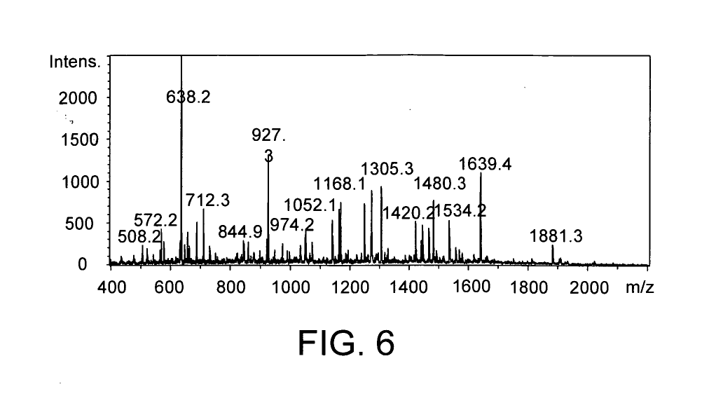

FIG. 5 illustrates a MALDI measurement using a titanium nitride surface, while FIG. 6 illustrates a MALDI measurement on nanostructured Au/Si/SiO₂ surface. AP Maldi experiments were carried out with Agilent ion trap LC/MSD Ion Trap Plus. The nitrogen laser at 337 nm (10 Hz) was used as source. Ion trap accumulation was synchronized with laser firing. Ions from two laser shots were accumulated for each microscan. Each spectrum was an average of 16 microscans. 0.5 min of data (8 spectra was collected, representing total of 256 laser shots. Both Agilent TiN (Agilent G1972-60025) substrate and the nanostructured Au/Si/SiO₂ substrate were used. Standard BSA digest was spotted at 500 attomole in 0.25 mg/ml CHCN matrix. The following results showed nanostructured Au/Si/SiO₂ substrate provided better results.

We claim:

1. A matrix assisted laser desorption ionization (MALDI) sample substrate, comprising:
a substrate,
a metal nanostructure catalyst layer disposed on the substrate, wherein the metal nanostructure catalyst layer includes a discrete set of nanostructures of the metal nanostructure catalyst layer,
a silicon nanostructure layer disposed on the metal nanostructure catalyst layer, wherein the silicon nanostructure layer includes a discrete set of nanostructures of the silicon nanostructure layer, and
a silicon dioxide (SiO₂) layer formed on the silicon nanostructure layer.

2. The MALDI sample substrate of claim 1, wherein the metal nanostructure catalyst layer includes a metal nanostructure, wherein the metal nanostructure includes a metal selected from: gold, silver, titanium, nickel, cobalt, oxides of each, and combinations of each.

3. The MALDI sample substrate of claim 2, wherein the metal nanostructure comprises gold.

4. The MALDI sample substrate of claim 2, wherein the metal nanostructure catalyst layer has a thickness of about 2 to 50 nanometers (nm).

5. The MALDI sample substrate of claim 1, wherein the silicon nanostructure layer has a thickness of about 2 to 50 nanometers (nm).

6. The MALDI sample substrate of claim 1, wherein the silicon dioxide (SiO₂) layer has a thickness of about 2 to 10 angstroms (Å).

7. The MALDI sample substrate of claim 1, wherein the metal nanostructure catalyst layer is configured to reflect an incident light towards a sample.

8. A mass spectrometry system, comprising:
an ion source configured to produce ions and comprising:
a light source; and
a sample support adjacent the light source and configured to support a sample, the sample support comprising:
a matrix assisted laser desorption ionization (MALDI) substrate,
a metal nanostructure catalyst layer disposed on the MALDI substrate, wherein the metal nanostructure catalyst layer includes a discrete set of nanostructures of the metal nanostructure catalyst layer,
a silicon nanostructure layer disposed on the metal nanostructure catalyst layer, wherein the silicon nanostructure layer includes a discrete set of nanostructures of the silicon nanostructure layer, and
a silicon dioxide (SiO₂) layer disposed on the silicon nanostructure layer; and
a detector downstream with respect to the ion source and configured to detect the ions.

9. The mass spectrometry system of claim 8, wherein the light source comprises a laser that is configured to produce incident light.

10. The mass spectrometry system of claim 8, wherein the metal nanostructure catalyst layer is configured to reflect incident light from the light source towards the sample.

11. A method of ionizing a sample, comprising:
providing a sample support comprising:
a matrix assisted laser desorption ionization (MALDI) substrate,
a metal nanostructure catalyst layer disposed on the MALDI substrate, wherein the metal nanostructure catalyst layer includes a discrete set of nanostructures of the metal nanostructure catalyst layer,
a silicon nanostructure layer disposed on the metal nanostructure catalyst layer, wherein the silicon nanostructure layer includes a discrete set of nanostructures of the silicon nanostructure layer, and
a silicon dioxide (SiO₂) layer disposed on the silicon nanostructure layer;
positioning the sample on the sample support; and
ionizing the sample.

12. The method of claim 11, wherein the metal nanostructure catalyst layer is configured to reflect the incident light towards the sample.

13. A method of fabricating a matrix assisted laser desorption ionization (MALDI) sample substrate comprising:
providing a substrate;
forming a metal nanostructure catalyst layer on the substrate, wherein the metal nanostructure catalyst layer includes a discrete set of nanostructures of the metal nanostructure catalyst layer;
forming a silicon nanostructure layer on the metal nanostructure catalyst layer, wherein the silicon nanostructure layer includes a discrete set of nanostructures of the silicon nanostructure layer; and
forming a silicon dioxide (SiO₂) layer disposed on the silicon nanostructure layer.

14. The method of claim 13, wherein forming the silicon nanostructure layer includes heating to a deposition temperature of about 400 to 700° C. and passing a gaseous precursor mixture over the substrate and metal nanostructure catalyst layer, wherein the gaseous precursor mixture contains a Si precursor selected from: silane (SiH₄) and disilane (Si₂H₆).
